(19) United States
(12) Patent Application Publication
(10) Pub. No.: US 2017/0068418 A1
(43) Pub. Date: Mar. 9, 2017

(54) ELECTRONIC APPARATUS, RECORDING MEDIUM, AND OPERATION METHOD OF ELECTRONIC APPARATUS

(71) Applicant: KYOCERA CORPORATION, Kyoto (JP)

(72) Inventor: Nao TANAKA, Tokyo (JP)

(21) Appl. No.: 15/356,301

(22) Filed: Nov. 18, 2016

Related U.S. Application Data
(63) Continuation of application No. PCT/JP2015/065345, filed on May 28, 2015.

(30) Foreign Application Priority Data
May 28, 2014 (JP) 2014-110536

(51) Int. Cl. G06F 3/0481; G06F 3/16

(52) U.S. Cl. CPC G06F 3/04812; G06F 3/167

(57) ABSTRACT

An electronic apparatus, a non-transitory computer-readable recording medium, and an operation method of an electronic apparatus are disclosed. A display performs a display in a display area. A detector detects an operation performed on the display area by an operator. The display displays, in the display area, a cursor for selecting a display object to be displayed in the display area. The display moves the cursor in the display area in accordance with a movement of the operator in the display area detected by the detector and moves the cursor by an amount of movement greater than an amount of movement of the operator. When the cursor approaches within a predetermined distance of a display object in the display area, the display snaps the cursor to the display object in such a manner that the display object is selected by the operator.

### CROSS-REFERENCE TO RELATED APPLICATION

The present application is a continuation of International Application No. PCT/JP2015/065345, filed on May 28, 2015, which claims the benefit of Japanese Patent Application No. 2014-110536, filed on May 28, 2014. International Application No. PCT/JP2015/065345 is entitled “ELECTRONIC APPARATUS, RECORDING MEDIUM, AND METHOD FOR OPERATING ELECTRONIC APPARATUS”, and Japanese Patent Application No. 2014-110536 is entitled “ELECTRONIC APPARATUS, CONTROL PROGRAM, AND OPERATION METHOD OF ELECTRONIC APPARATUS”. The content of these applications is incorporated herein by reference in their entirety.

### FIELD

Embodiments of the present disclosure relate to electronic apparatuses.

### BACKGROUND

Various techniques have conventionally been proposed for electronic apparatuses.

### SUMMARY

An electronic apparatus, a non-transitory computer-readable recording medium, and an operation method of an electronic apparatus are disclosed.

In one embodiment, an electronic apparatus comprises a display and a detector. The display performs a display in a display area. The detector detects an operation performed on the display area by an operator. The display displays, in the display area, a cursor for selecting a display object to be displayed in the display area. The display moves the cursor in the display area in accordance with a movement of the operator in the display area detected by the detector and moves the cursor by an amount of movement greater than an amount of movement of the operator. When the cursor approaches within a predetermined distance of a display object in the display area, the display snaps the cursor to the display object in such a manner that the display object is selected by the operator.

In one embodiment, an electronic apparatus comprises a display, a detector, and a sound output unit. The display performs a display in a display area. The detector detects an operation performed on the display area by an operator. The sound output unit outputs a sound. The display displays, in the display, a cursor for selecting a display object to be displayed in the display. The display moves the cursor in the display area in accordance with a movement of the operator in the display area detected by the detector and moves the cursor by an amount of movement greater than an amount of movement of the operator. The sound output unit outputs, when a display object to be displayed in the display area is selected by the operator, a voice of explanation for explaining the display object.

In one embodiment, a non-transitory computer-readable recording medium stores a control program that controls an electronic apparatus including a display area. The control program causes the electronic apparatus to execute the steps of (a) detecting an operation performed on the display area by an operator, and (b) displaying, in the display area, a cursor for selecting a display object to be displayed in the display area. In the step (b), the cursor is moved in the display area in accordance with a movement of the operator in the display area detected in the step (a), and the cursor is moved by an amount of movement greater than an amount of movement of the operator. When the cursor approaches within a predetermined distance of the display object in the display area, the cursor is snapped to the display object in such a manner that the display object is selected by the operator.

In one embodiment, a non-transitory computer-readable recording medium stores a control program that controls an electronic apparatus including a display area. The control program causes the electronic apparatus to execute the steps of (a) detecting an operation performed on the display area by an operator, (b) displaying, in the display area, a cursor for selecting a display object to be displayed in the display area, and (c) outputting a sound. In the step (b), the cursor is moved in the display area in accordance with a movement of the operator in the display area detected in the step (a), and the cursor is moved by an amount of movement greater than an amount of movement of the operator. In the step (c), when a display object to be displayed in the display area is selected by the operator, a voice of explanation for explaining the display object is output.

In one embodiment, an operation method of an electronic apparatus including a display area comprises (a) detecting an operation performed on the display area by an operator, and (b) displaying, in the display area, a cursor for selecting a display object to be displayed in the display area. In the step (b), the cursor is moved in the display area in accordance with a movement of the operator in the display area detected in the step (a), and the cursor is moved by an amount of movement greater than an amount of movement of the operator. When the cursor approaches within a predetermined distance of the display object in the display area, the cursor is snapped to the display object in such a manner that the display object is selected by the operator.

In one embodiment, an operation method of an electronic apparatus including a display area comprises (a) detecting an operation performed on the display area by an operator, (b) displaying, in the display area, a cursor for selecting a display object to be displayed in the display area, and (c) outputting a sound. In the step (b), the cursor is moved in the display area in accordance with a movement of the operator in the display area detected in the step (a), and the cursor is moved by an amount of movement greater than an amount of movement of the operator. In the step (c), when a display object to be displayed in the display area is selected by the operator, a voice of explanation for explaining the display object is output.

### BRIEF DESCRIPTION OF THE DRAWINGS

FIG. 1 illustrates a front view of an external appearance of an electronic apparatus.

FIG. 2 illustrates a rear view of the external appearance of the electronic apparatus.

FIG. 3 illustrates a block diagram showing an electrical configuration of the electronic apparatus.

FIG. 4 illustrates a display example of the electronic apparatus.

FIG. 5 illustrates how a user holds the electronic apparatus with a right hand.

FIG. 6 illustrates how a user holds the electronic apparatus with a left hand.

FIG. 7 illustrates an operation example performed on a display area of the electronic apparatus by an operator.

FIG. 8 illustrates an operation example performed on the display area of the electronic apparatus by the operator.

FIG. 9 illustrates an operation example performed on the display area of the electronic apparatus by the operator.

FIG. 10 illustrates an operation example performed on the display area of the electronic apparatus by the operator.

FIG. 11 illustrates an XY orthogonal coordinate system set to the display area of the electronic apparatus.

FIG. 12 illustrates a display example of the electronic apparatus.

FIG. 13 illustrates an operation of the electronic apparatus.

FIG. 14 illustrates a flowchart showing the operation of the electronic apparatus.

FIG. 15 illustrates an operation of the electronic apparatus.

FIG. 16 illustrates an operation of the electronic apparatus.

FIG. 17 illustrates an operation example performed on the display area of the electronic apparatus by an operator.

FIG. 18 illustrates a display example of the electronic apparatus.

FIG. 19 illustrates a flowchart showing an operation of the electronic apparatus.

FIG. 20 illustrates the electronic apparatus.

### DETAILED DESCRIPTION

### External Appearance of Electronic Apparatus

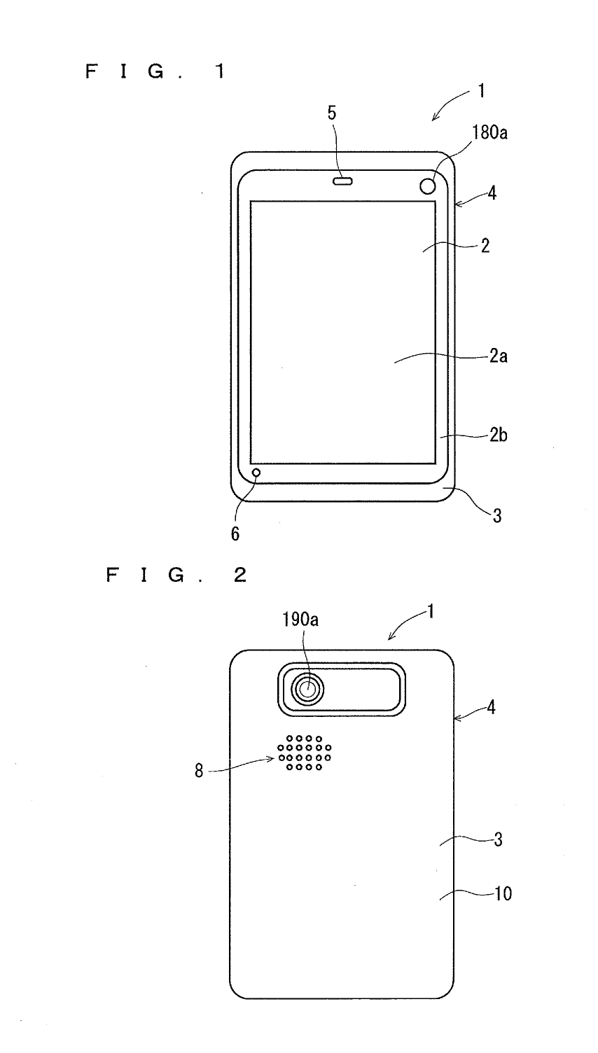

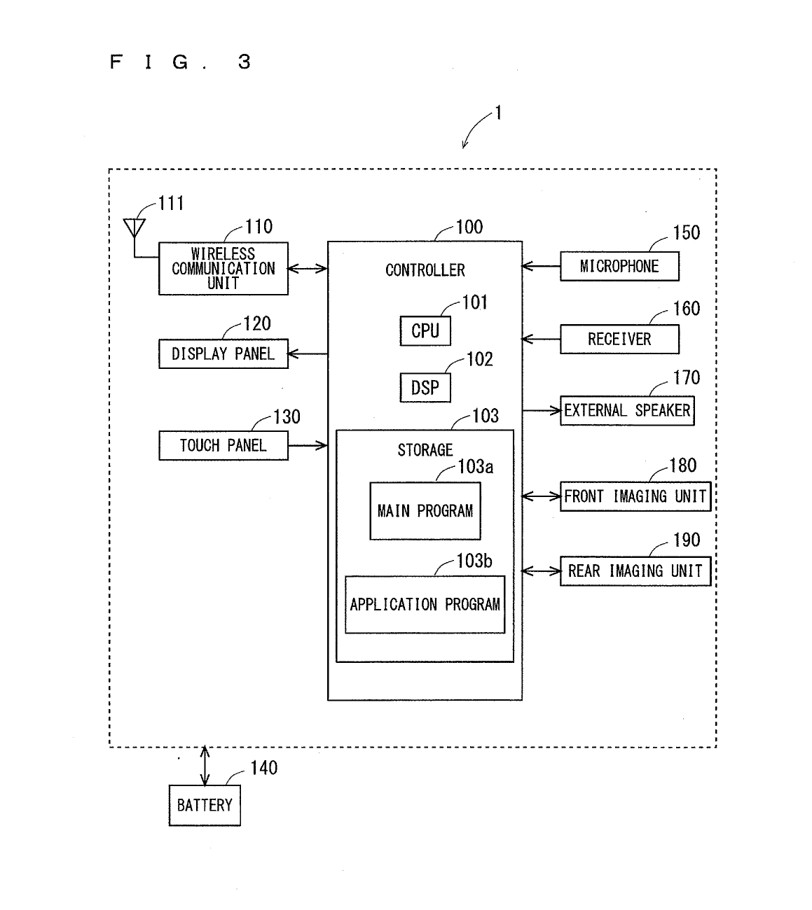

FIGS. 1 and 2 are respectively a front view and a rear view illustrating an external appearance of an electronic apparatus 1. The electronic apparatus 1 is, for example, a mobile phone such as a smartphone. The electronic apparatus 1 can communicate with another communication apparatus through a base station, a server, or the like.

As illustrated in FIGS. 1 and 2, the electronic apparatus 1 includes a cover panel 2 and a case part 3. The combination of the cover panel 2 and the case part 3 is an apparatus case 4 having a plate shape substantially rectangular in a plan view.

The cover panel 2 is substantially rectangular in a plan view. The cover panel 2 is a portion other than the peripheral edge portion in the front portion of the electronic apparatus 1. The cover panel 2 is formed of, for example, a transparent glass or a transparent acrylic resin. The case part 3 comprises the peripheral edge portion in the front portion, the side portion, and the rear portion of the mobile electronic apparatus 1. The case part 3 is formed of, for example, a polycarbonate resin. The materials for the cover panel 2 and the case part 3 are not limited to the above.

The front surface of the cover panel 2 comprises a display area 2a on which various pieces of information such as characters, symbols, and graphics are displayed. The display area 2a is, for example, rectangular in a plan view. A peripheral edge portion 2b of the cover panel 2 surrounding the display area 2a is opaque because of, for example, a film attached thereto. The peripheral edge portion 2b is accordingly a non-display portion on which no information is displayed.

A touch panel 130, which will be described below, is stuck on the rear surface of the cover panel 2. The user can provide various instructions to the electronic apparatus 1 by operating the display area 2a on the front surface of the electronic apparatus 1 with, for example, a finger. The user can provide various instructions to the electronic apparatus 1 also by operating the display area 2a with an operator other than the finger, such as, pens for electrostatic touch panels including a stylus pen. Provided in a lower end portion of the cover panel 2 is a microphone hole 6.

Provided in an upper end portion of the cover panel 2 is a receiver hole 5. An imaging lens 180a of a front imaging unit 180, which will be described below, is visually recognizable from the upper end portion on the front surface of the cover panel 2. As illustrated in FIG. 2, provided in a rear surface 10 of the electronic apparatus 1, or, the rear surface of the apparatus case 4 are speaker holes 8. An imaging lens 190a of a rear imaging unit 190, which will be described below, is visually recognizable from the rear surface 10 of the electronic apparatus 1.

Electrical Configuration of Electronic Apparatus

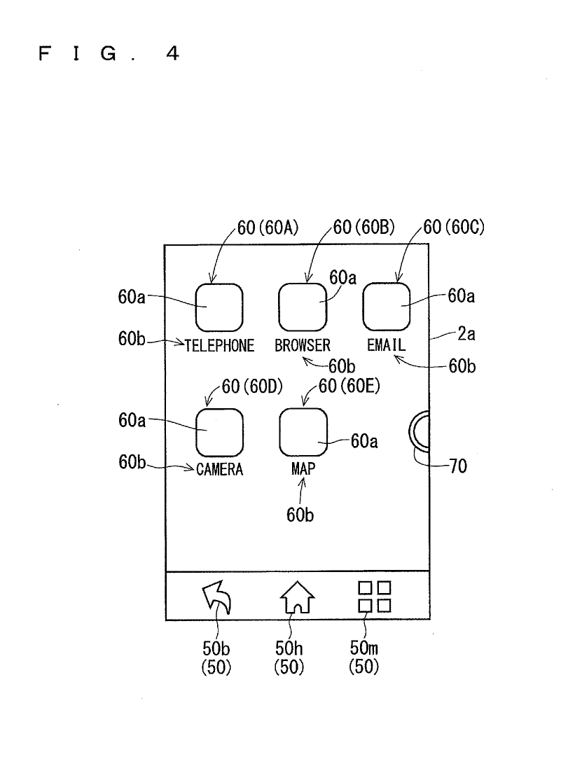

FIG. 3 illustrates a block diagram showing an electrical configuration of the electronic apparatus 1. As illustrated in FIG. 3, the electronic apparatus 1 includes a controller 100, a wireless communication unit 110, a display panel 120, a touch panel 130, and a battery 140. The electronic apparatus 1 further includes a microphone 150, a receiver 160, an external speaker 170, a front imaging unit 180, and a rear imaging unit 190. The apparatus case 4 houses these components included in the electronic apparatus 1.

The controller 100 includes, for example, a central processing unit (CPU) 101, a digital signal processor (DSP) 102, and storage 103. The controller 100 can manage the overall operation of the electronic apparatus 1 by controlling the other constituent elements of the electronic apparatus 1.

The storage 103 comprises a non-transitory recording medium readable by the controller 100 (the CPU 101 and the DSP 102), such as a read only memory (ROM) and a random access memory (RAM). The storage 103 stores, for example, a main program 103a and a plurality of application programs 103b. The main program 103 is a control program for controlling the operation of the electronic apparatus 1, specifically, the constituent elements of the electronic apparatus 1 such as the wireless communication unit 110 and the display panel 120. The CPU 101 and the DSP 102 execute the various programs in the storage 103 to achieve various functions of the controller 100. FIG. 3 illustrates a single application program 103b for the sake of brevity.

The storage 103 may include a non-transitory computer-readable recording medium other than the ROM and the RAM. The storage 103 may include, for example, a compact hard disk drive and a solid state drive (SSD).

The wireless communication unit 110 includes an antenna 111. The wireless communication unit 110 can receive through, for example, a base station a signal from another mobile phone different from the electronic apparatus 1 or a communication apparatus such as a web server connected to the Internet. The wireless communication unit 110 can amplify and down-convert a received signal and output a resultant signal to the controller 100. The controller 100 can, for example, demodulate the received signal to acquire a sound signal indicative of the voice or music contained in the received signal. The wireless communication unit 110 can up-convert and amplify a transmission signal including a sound signal, generated by the controller 100, and wirelessly transmit the processed transmission signal through the antenna 111. The other mobile phone different from the electronic apparatus 1 or the communication apparatus connected to the Internet receives the transmission signal from the antenna 111 through, for example, the base station.

The display panel 120 is, for example, a liquid crystal display panel or an organic electroluminescent (EL) panel. The display panel 120 can display various pieces of information such as characters, symbols, and graphics by control of the controller 100. The information displayed on the display panel 120 is displayed in the display area 2a on the front surface of the cover panel 2. It thus can be said that the display panel 120 performs a display in the display area 2a.

The touch panel 130 can detect an operation performed on the display area 2a of the cover panel 2 by an operator, such as a finger. The touch panel 130 is, for example, a projected capacitive touch panel and is stuck on the rear surface of the cover panel 2. When the user operates the display area 2a of the cover panel 2 using the operator such as a finger, the touch panel 130 can enter an electrical signal corresponding to the operation into the controller 100. The controller 100 can identify the content of the operation performed on the display area 2a based on the electrical signal from the touch panel 130 and perform a process corresponding to the identified content.

The detection sensitivity of the touch panel 130 is set high in the electronic apparatus 1. The touch panel 130 can accordingly detect not only the contact of the operator with the display area 2a but also the proximity of the operator to the display area 2a. Specifically, the detection sensitivity of the touch panel 130 is set in such a manner that the touch panel 130 shows a reaction when the operator comes close to the display area 2a. The touch panel 130 can thus detect not only that the operator in contact with the display area 2a moves away from the display area 2a but also that the operator in proximity to the display area 2a moves away from the display area 2a.

In one embodiment of the present disclosure, that the operator moves away from the display area 2a means not only that the operator in contact with the display area 2a moves away from the display area 2a but also that the operator in proximity to the display area 2a moves away from the display area 2a.

The microphone 150 can convert the sound from the exterior of the electronic apparatus 1 into an electrical sound signal and then output the sound signal to the controller 100. The sound from the exterior of the electronic apparatus 1 is taken into the electronic apparatus 1 through the microphone hole 6 located in the front surface of the cover panel 2 and is entered into the microphone 150.

The external speaker 170 is, for example, a dynamic speaker. The external speaker 170 can convert an electrical sound signal from the controller 100 into a sound and then output the sound. The sound output from the external speaker 170 is output to the exterior through the speaker holes 8 located in the rear surface of the electronic apparatus 1. The sound output from the speaker holes 8 can be heard in the place apart from the electronic apparatus 1.

The front imaging unit 180 includes an imaging lens 180a and an image sensor. The front imaging unit 180 can image a still image and a video under the control of the controller 100. As illustrated in FIG. 1, the imaging lens 180a is located in the front surface of the electronic apparatus 1. The front imaging unit 180 can thus image an object located in front of the electronic apparatus 1 (on the cover panel 2 side).

The rear imaging unit 190 includes an imaging lens 190a and an image sensor. The rear imaging unit 190 can image a still image and a video under the control of the controller 100. As illustrated in FIG. 2, the imaging lens 190a is located in the rear surface of the electronic apparatus 1. The rear imaging unit 190 can thus image an object located on the rear surface 10 side of the electronic apparatus 1.

The receiver 160 can output the received sound. The receiver 160 is, for example, a dynamic speaker. The receiver 160 can convert an electrical sound signal from the controller 100 into a sound and then output the sound. The sound output from the receiver 160 is output to the exterior through the receiver hole 5 located in the front surface of the electronic apparatus 1. The volume of the sound output through the receiver hole 5 is lower than the volume of the sound output through the speaker holes 8.

The battery 140 can output a power source for the electronic apparatus 1. The power source output from the battery 140 is supplied to various electronic components included in the controller 100 and the wireless communication unit 110 of the electronic apparatus 1.

The storage 103 can store various application programs 103b (hereinbelow merely referred to as “applications 103b”). The storage 103 stores, for example, a telephone application for calling using a telephone function, a browser for displaying a web site, and a mail application for creating, looking at, and transmitting and receiving electric mail. The storage 103 also stores a camera application for capturing images using the front imaging unit 180 and the rear imaging unit 190, a map display application for displaying a map, a television application for viewing and recording a television program, a music playback control application for controlling playback of music data stored in the storage 103, and any other application.

When the controller 100 executing the main program 103a in the storage 103 reads and executes the application 103b in the storage 103, the controller 100 controls the other constituent elements of the electronic apparatus 1, such as the wireless communication unit 110, the display panel 120, and the receiver 160. The electronic apparatus 1 can accordingly execute the function (process) corresponding to the application 103b. For example, the controller 100 executing the telephone application controls the wireless communication unit 110, the microphone 150, and the receiver 160. In the electronic apparatus 1, accordingly, the receiver 160 outputs the sound included in the signal received by the wireless communication unit 110, and the wireless communication unit 110 transmits the transmission signal including the sound entered into the microphone 150, enabling a call with the calling party using the telephone function.

Types of Operations on Display Area with Operator

Examples of the basic operations that the user performs on the display area 2a with the operator include sliding, tapping, and flicking.

Sliding is an operation in which an operator such as a finger moves while being in contact with or in proximity to the display area 2a. In other words, sliding is an operation in which the operator moves in the display area 2a. The user can slide the display area 2a to, for example, scroll a display of the display area 2a or switch a page displayed in the display area 2a to another page. In one embodiment, operations in which the operator moves in the display area 2a include the operation in which the operator moves while being in contact with the display area 2a and the operation in which the operator moves while being in proximity to the display area 2a.

Tapping is an operation in which the operator comes into contact with or comes close to the display area 2a and then immediately moves away from the display area 2a. Specifically, tapping is an operation in which the operator comes into contact with or comes close to the display area 2a and moves away from the display area 2a at the position at which the operator has been in contact with or in proximity to the display area 2 before a predetermined period of time expires from the contact with or proximity to the display area 2a. The user can tap the display area 2a to, for example, select an application icon (hereinbelow, referred to as an “app icon”) for executing the application 103b, which is displayed in the display area 2a, thereby causing the electronic apparatus 1 to execute the application 103b. The app icon can be said to be a display object selectable by the user, which is displayed in the display area 2a. The app icon can be also said to be a display object corresponding to a function (such as a telephone function or a map display function) executed by the electronic apparatus 1 through the execution of the application 103b. Further, the app icon can be said to be a display object associated with the process of executing the application 103b.

Flicking is an operation of flicking the display area 2a by the operator. Specifically, flicking is an operation in which the operator moves while being in contact with or in proximity to the display area 2a for a predetermined distance or more within a predetermined period of time and then moves away from the display area 2a. The user can flick the display area 2a to, for example, scroll a display of the display area 2a in the direction of the flicking or switch a page displayed in the display area 2a to another page.

Display Example of Display Area

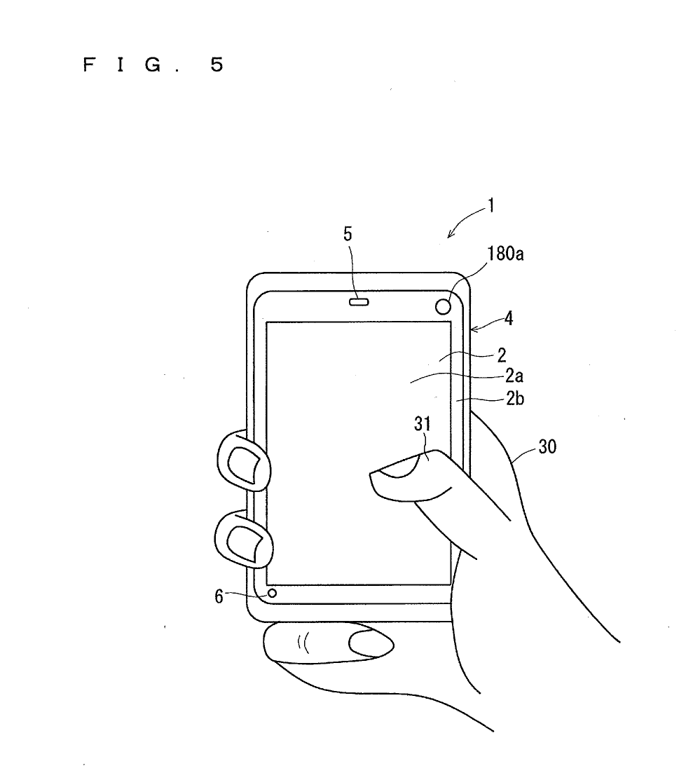

FIG. 4 illustrates a display example of the display area 2a. As illustrated in FIG. 4, a back key 50b, a home key 50h, and a menu key 50m are displayed in the display area 2a. The back key 50b, the home key 50h, and the menu key 50m are always displayed in the display area 2a. Each of the back key 50b, the home key 50h, and the menu key 50m is a display object selectable by the user, which is displayed in the display area 2a, similarly to the app icon. Hereinbelow, a “display object” means a display object selectable by the user.

The back key 50b is a software key for returning a display of the display area 2a to the last display. When the user, for example, taps the back key 50b, the display of the display area 2a returns to the last display.

The home key 50h is a software key for displaying the home screen (initial screen) in the display area 2a. When the user, for example, taps the home key 50h, the home screen is displayed in the display area 2a.

The menu key 50m is a software key for displaying an optional menu screen. When the user, for example, taps the menu key 50m, the optional menu screen is displayed in the display area 2a.

Hereinbelow, the back key 50b, the home key 50h, and the menu key 50m may be each referred to as an “operation key 50” if they do not need to be differentiated from each other. Each of the back key 50b, the home key 50h, and the menu key 50m may be a hardware key, not a software key.

An app icon 60 is displayed in the display area 2a. In the example of FIG. 4, an app icon 60A for executing a telephone application, an app icon 60B for executing a browser, an app icon 60C for executing a mail application, an app icon 60D for executing a camera application, and an app icon 60E for displaying a map display application are displayed in the display area 2a. Each app icon 60 includes graphics 60a indicating its corresponding application and a text 60b for explaining the application. When the user taps the app icon 60, the controller 100 executes an application corresponding to the app icon 60.

Although the shape of the graphics 60a of the app icon 60 is simplified into a substantially rectangular shape in FIG. 4, in actuality, the shape of the graphics 60a of the app icon 60 fits for the application (function) to which the app icon 60 corresponds.

Further, a cursor 70 for selecting a display object to be displayed in the display area 2a is displayed in the display area 2a. The cursor 70 is always displayed in the display area 2a. The cursor 70 moves in the display area 2a, in accordance with the movement of the operator in the display area 2a detected by the touch panel 130. The user can thus move the operator to move the cursor 70 in the display area 2a. The user can directly select the display objects such as the app icon 60 and the operation key 50 to be displayed in the display area 2a with the operator and also select the display objects with the cursor 70. The cursor 70 will be described below in detail.

How User Operates Electronic Apparatus

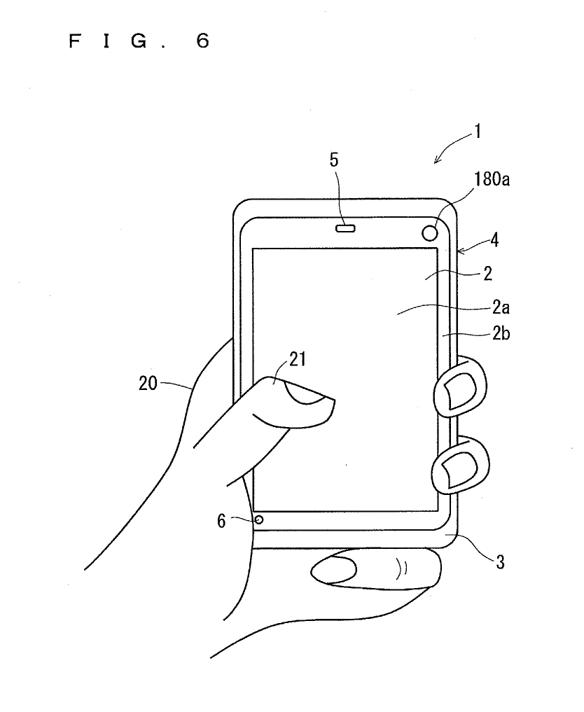

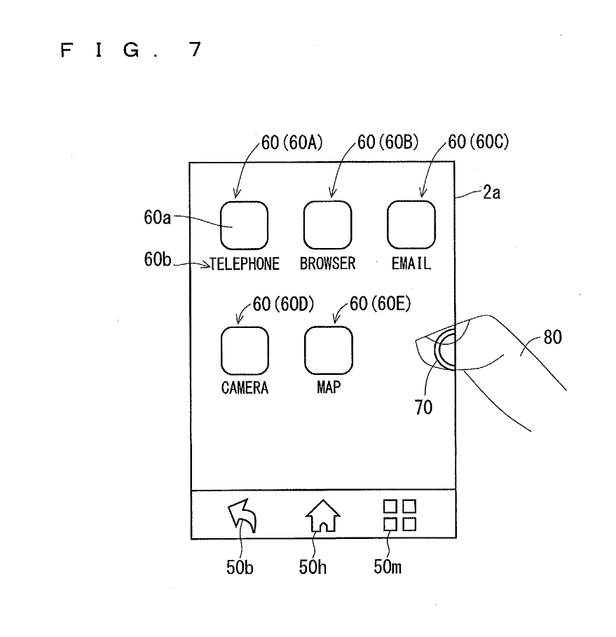

FIGS. 5 and 6 illustrate examples of how the user operates the electronic apparatus 1. FIG. 5 illustrates how the user operates the display area 2a with a thumb 31 of a right hand 30 while holding the electronic apparatus 1 with the right hand 30. FIG. 6 illustrates how the user operates the display area 2a with a thumb 21 of a left hand 20 while holding the electronic apparatus 1 with the left hand 20.

As illustrated in FIGS. 5 and 6, when operating the display area 2a with a thumb while holding the electronic apparatus 1 with one hand, the user may have difficulty in operating the edge portion of the display area 2a. Specifically, the user may have difficulty in selecting a display object such as an app icon or a link in a web page (also referred to as a “hyperlink”), which is displayed at the edge portion of the display area 2a, with a thumb. Such a difficulty becomes serious as the screen becomes larger along with an increased size of the display area 2a.

The electronic apparatus 1 can display, in the display area 2a, a cursor (pointer) 70 similar to a mouse cursor (also referred to as a “mouse pointer”) used in a personal computer or the like. The user can operate the display area 2a to move the cursor 70 in the display area 2a. The user can accordingly operate the electronic apparatus 1 with ease even when operating the electronic apparatus 1 with one hand as illustrated in FIGS. 5 and 6. This will be described below in detail.

As an example, a thumb of the user's right hand is mainly illustrated as the operator 80 that operates the display area 2a in the figures below, assuming the case where the user operates the display area 2a with the thumb 31 of the right hand 30 while holding the electronic apparatus 1 with the right hand 30, as illustrated in FIG. 5. The following description also holds true for the case where the operator 80 is any other operator.

Modes of Operation of Electronic Apparatus

Operation modes of the electronic apparatus 1 include a cursor-used mode and an initial position change mode. The state of the electronic apparatus 1 in which the electronic apparatus 1 operates in neither the cursor-used mode nor the initial position change mode is referred to as a “normal mode”. In the cursor-used mode, the cursor 70 moves in accordance with a movement of the operator 80, thus enabling the operation performed on the display object by the cursor 70 and disabling the operation performed on a display object by the operator 80. In the normal mode, contrastingly, the cursor 70 does not move, thus enabling the operation performed on a display object by the operator 80.

Operation Example in Normal Mode

In the normal mode, when the operator 80 comes into contact with or comes close to a display object, the display object is selected. In the normal mode, as described above, when an app icon 60 in the display area 2a is tapped by the operator 80, the app icon 60 is selected, and accordingly, the process associated with the app icon 60, or, the application corresponding to the app icon 60 is executed. In the normal mode, also, when an operation key 50 in the display area 2a is tapped by the operator 80, the process associated with the operation key 50 is executed.

Cursor-Used Mode

With the display area 2a not operated by the operator, as illustrated in FIG. 4 described above, the cursor 70 is displayed at the center in the longitudinal direction of the display area 2a at the right edge of the display area 2a. Hereinbelow, the position of the cursor 70 with the display area 2a not operated by the operator is referred to as an “initial position”. In one embodiment, the position of the cursor 70 means, for example, the position of the center of the cursor 70. In one embodiment, the cursor 70 has a shape of, for example, a double circle. In the display of the cursor 70 at the initial position, as illustrated in FIG. 4, only the left half of the cursor 70 is displayed in the display area 2a. The shape of the cursor 70 is not limited to this shape.

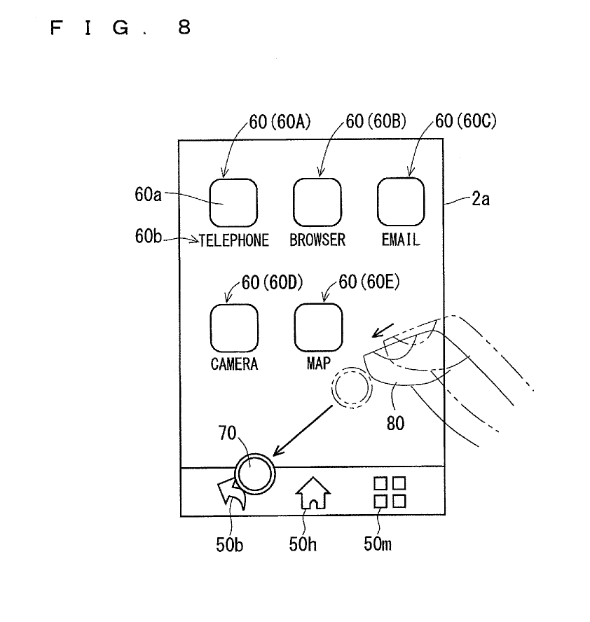

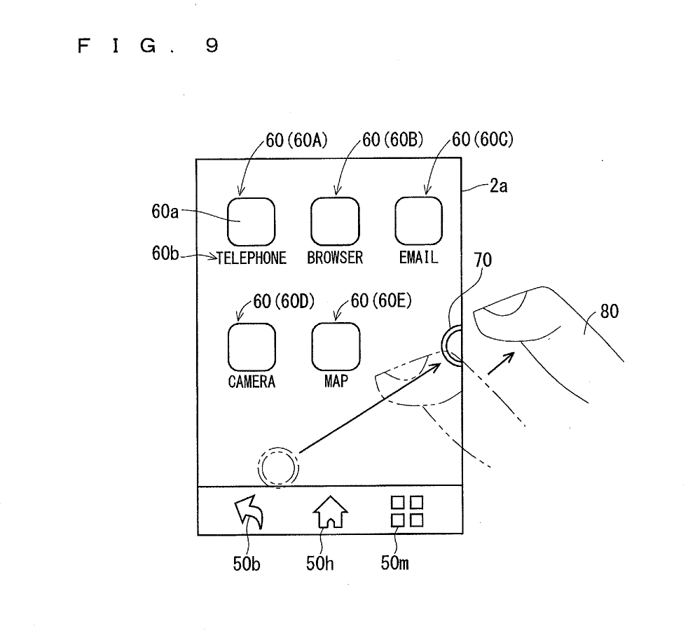

When the operator 80 comes into contact with or close to the cursor 70 displayed at the initial position as illustrated in FIG. 7 and moves in the display area 2a before a predetermined period of time expires from the contact with or proximity to the cursor 70, the controller 100 shifts the operation mode of the electronic apparatus 1 from the normal mode to the cursor-used mode. In the cursor-used mode, as illustrated in FIG. 8, the cursor 70 moves in accordance with the movement of the operator 80, and also, the cursor 70 moves more than the operator 80 does.

When the operator 80 has been in contact with or in proximity to the cursor 70 displayed at the initial position for a predetermined period of time or more, the controller 100 shifts the operation mode of the electronic apparatus 1 from the normal mode to the initial position change mode, in which the initial position of the cursor 70 is changeable. The initial position change mode will be described below in detail.

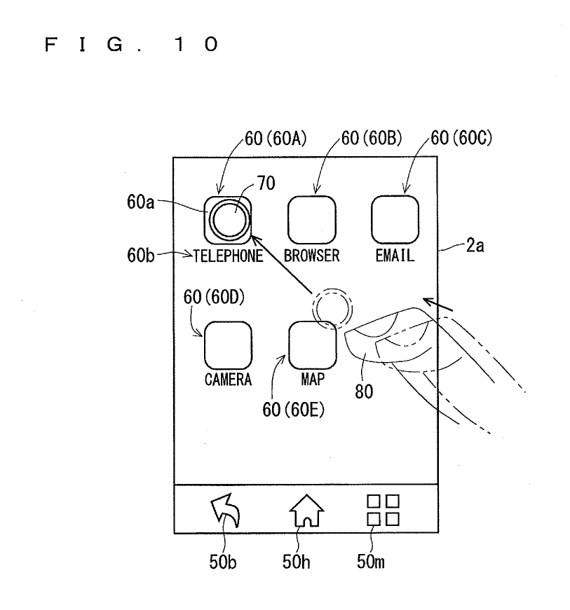

In one embodiment, when the cursor 70 is positioned on a display object such as the app icon 60a, the display object is selected. Specifically, when the cursor 70 is positioned on a display object and a distance between the display object and the cursor 70 is not greater than a predetermined distance, the display object is selected. Hereinbelow, the predetermined distance will be referred to as a “first predetermined distance”. In one embodiment, the distance between the display object and the cursor 70 means, for example, a distance between the center of the display object and the center of the cursor 70. In the cursor-used mode, when the operator 80 moves away from the display area 2a with a display object not selected by the operator 70 as illustrated in FIG. 9, the controller 100 shifts the operation mode of the electronic apparatus 1 from the cursor-used mode to the normal mode. When the operation mode of the electronic apparatus 1 shifts from the cursor-used mode to the normal mode, the position of the cursor 70 returns to the initial position.

The controller 100 may shift the operation mode of the electronic apparatus 1 from the cursor-used mode to the normal mode when the cursor 70 arrives at the edge (peripheral edge) of the display area 2a, irrespective of whether a display object has been selected by the operator 70. In this case, the controller 100 may shift the operation mode of the electronic apparatus 1 from the cursor-used mode to the normal mode immediately when the cursor 70 arrives at the edge of the display area 2a or may shift the operation mode of the electronic apparatus 1 from the cursor-used mode to the normal mode when the cursor 70 has stayed at the edge of the display area 2a for a predetermined period of time or more. In the presence of the cursor 70 at the edge of the display area 2a, only half of the cursor 70 is displayed in the display area 2a as in the case where the cursor 70 is positioned at the initial position.

When the touch panel 130 detects that the operator 80 has moved away from the display area 2a after the cursor 70 moves to be positioned on a display object in the display area 2a and the display object is selected, the electronic apparatus 1 performs the process associated with the display object selected by the operator 70. In the cursor-used mode, the operation in which the operator 80 moves away from the display area 2a is equivalent to tapping in the normal mode.

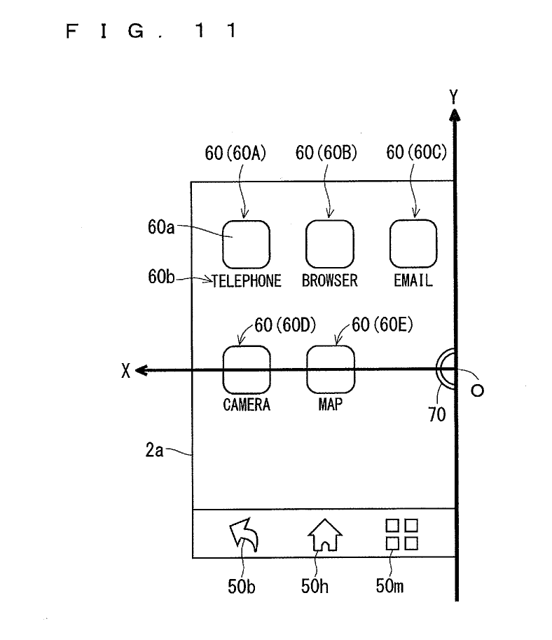

For example, the user moves the operator 80 in the display area 2a to position the cursor 70 on the app icon 60A as illustrated in FIG. 10, and then, when the touch panel 130 detects that the operator 80 has moved away from the display area 2a, the controller 100 selects the app icon 60A and the electronic apparatus 1 accordingly performs the process associated with the selected app icon 60A. Specifically, the controller 100 reads a telephone application corresponding to the selected app icon 60A from the storage 103 and executes the telephone application. In this case, the controller 100 functions as a process performing unit that performs the process associated with a display object in the display area 2a.

The user moves the operator 80 in the display area 2a to position the cursor 70 on the back key 50b, and then, when the touch panel 130 detects that the operator 80 has moved away from the display area 2a, the controller 100 accordingly selects the back key 50b and the electronic apparatus 1 performs the process associated with the selected back key 50b. Specifically, the controller 100 controls the display panel 120 to return the display of the display area 2a to the last display.

When the process associated with the display object selected by the operator 70 is performed, the operation mode of the electronic apparatus 1 shifts to the normal mode, and the cursor 70 is displayed at the initial position in the display area 2a.

When a display object is selected by the operator 70, for the user to easily understand that the display object is being selected, the display panel 120 may, for example, change a display color of the display object or change a display color of the surrounding of the display object so that attention is focused on the display object.

As described above, the user can select a display object in the display area 2a with the cursor 70 to cause the electronic apparatus 1 to perform a process associated with the display object.

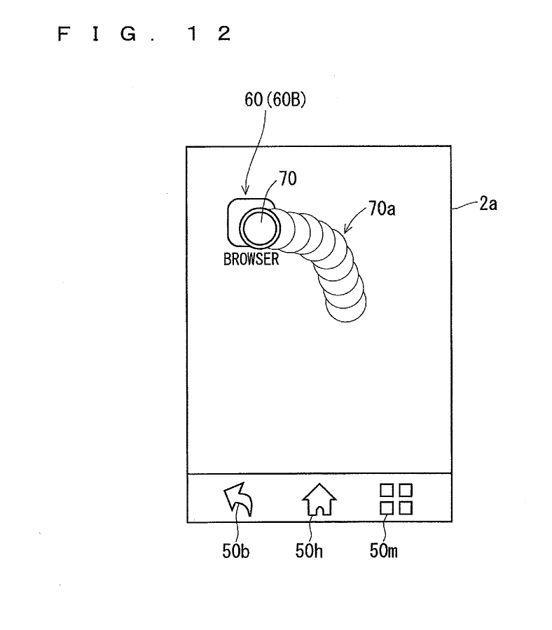

Next, description will be given of how the position of the cursor 70 changes in accordance with a movement of the operator 80. In the electronic apparatus 1, an XY orthogonal coordinate system with the initial position of the cursor 70 as an origin O, as illustrated in FIG. 11, is determined for the display area 2a. In the XY orthogonal coordinate system, an X axis extends in the left-right direction (transverse direction) of the display area 2a, and the leftward direction from the initial position of the cursor 70 is a +X direction. In the XY orthogonal coordinate system, a Y axis extends in the up-down direction (longitudinal direction) of the display area 2a, and the upward direction from the initial position of the cursor 70 is a +Y direction.

Coordinates (Sx, Sy) indicating the position of the cursor 70 in the XV orthogonal coordinate system are expressed by Expressions (1) and (2) below using coordinates (Ux, Uy) indicating the position at which the operator 80 is in contact with or in proximity to the display area 2a in the XY orthogonal coordinate system (hereinbelow merely referred to as the “position of the operator 80”).

Sx=Dx×Ux (1)

Sy=Dy×Uy (2)

In Expression (1), Dx represents a scaling factor in the X-axis direction, where Dx>1. In Expression (2), Dy represents a scaling factor in the Y-axis direction, where Dy>1.

From Expression (1), the X coordinate Sx of the position of the cursor 70 is Dx-times the X coordinate Ux of the position of the operator 80. From Expression (2), the Y coordinate Sy of the position of the cursor 70 is Dy-times the Y coordinate Uy of the position of the operator 80. In one embodiment, since the display area 2a is vertically long, for example, Dx is set to 3 and Dy is set to 4. The values of Dx and Dy are not limited to these values.

As can be seen from Expressions (1) and (2), when the cursor 70 moves in accordance with a movement of the operator 80 in the display area 2a, the cursor 70 moves more than the operator 80 does. The user can accordingly move the operator 80 in the display area 2a to move the cursor 70 in the display area 2a in such a manner that a mouse is moved to move a currently displayed mouse cursor in a personal computer. In other words, the user can move the operator 80 slightly to move the cursor 70 greatly. Thus, even when the user holds the electronic apparatus 1 with one hand (see FIGS. 5 and 6) and has difficulty in operating the edge portion of the display area 2a with a thumb (operator) of the one hand, the user can move the thumb slightly to move the cursor 70 to the edge portion of the display area 2a. This enables the user to easily select a display object displayed at the edge portion of the display area 2a even when having a difficulty in operating the edge portion of the display area 2a with a thumb of one hand holding the electronic apparatus 1. The user can accordingly operate the electronic apparatus 1 easily, resulting in improved operability of the electronic apparatus 1.

In the electronic apparatus 1, when the cursor 70 is positioned on a display object and the touch panel 130 then detects that the operator 80 has moved away from the display area 2a, the process associated with the display object is performed. Thus, merely by moving the operator 80 to move the cursor 70 to a display object and then moving the operator 80 away from the display area 2a, the user can cause the electronic apparatus 1 to perform the process associated with the display object selected by the operator 70. Thus, the operability of the electronic apparatus 1 by the user is much simplified. The operability of the electronic apparatus 1 is improved further.

The values of the scaling factors Dx and Dy may be changed by the user operating the display area 2a with the operator 80.

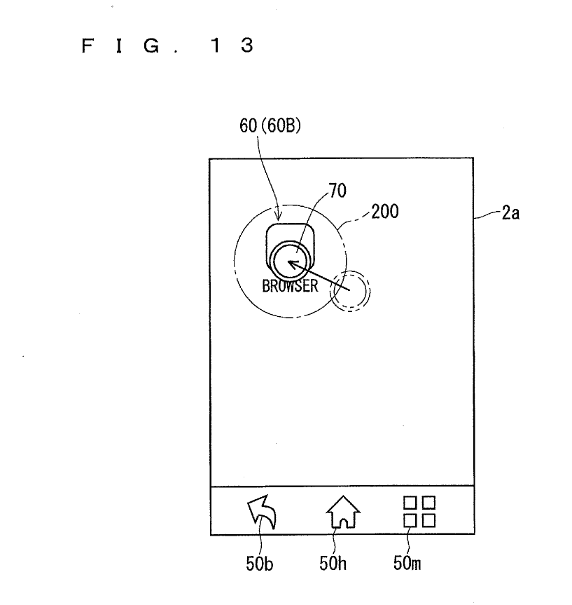

In the cursor-used mode, as illustrated in FIG. 12, a path 70a of the movement of the cursor 70 may be displayed in the display area 2a.

Various Functions in Cursor-Used Mode

The electronic apparatus 1 operated in the cursor-used mode executes a snap function and a talkback function. The snap function is a function of snapping, when the cursor 70 moves to be adjacent to a display object in the display area 2a, the cursor 70 to the display object. The talkback function is a function of outputting, when a display object is selected by the operator 70, a voice of explanation for explaining the display object. The snap function and the talkback function will be described below in detail.

Snap Function

In the cursor-used mode, the cursor 70 moves more than the operator 80 does, or, just a slight movement of the operator 80 moves the cursor 70 greatly. The user may thus have more difficulty in selecting a desired display object with the cursor 70 than in the case where the cursor 70 and the operator 80 move in the exact same way.

When the cursor 70 approaches within a second predetermined distance of the display object in the display area 2a, the display panel 120 that performs a display in the display area 2a snaps the cursor 70 to a display object in such a manner that the display object is selected by the cursor 70. Herein, the second predetermined distance is set to be greater than the first predetermined distance that serves as a reference to determine whether a display object has been selected by the operator 70. For example, when the center of the cursor 70 approaches within the second predetermined distance of the center of the display object, Expressions (1) and (2) above are not used, and the cursor 70 is forced to move in such a manner that the center of the cursor 70 coincides with the center of the display object.

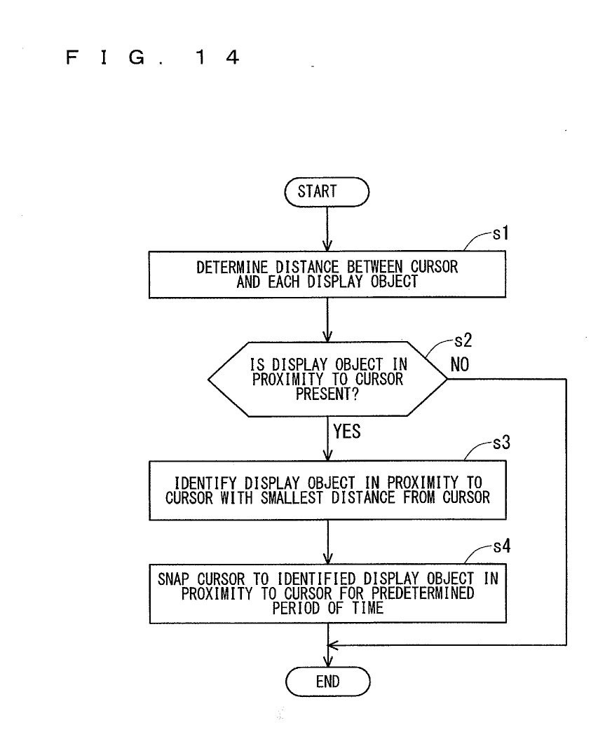

FIG. 13 illustrates how the cursor 70 is snapped to a display object. FIG. 13 illustrates how the cursor 70 is snapped to the app icon 60B in such a manner that the app icon 60B is selected by the operator 70, when the cursor 70 approaches within the second predetermined distance of the app icon 60B. An alternate long and short dash line 200 illustrated in FIG. 13 indicates the range of the second predetermined distance from the app icon 60B (more specifically, the center of the app icon 60B). In FIG. 13, a chain double-dashed line indicates the cursor 70 before being snapped, and a solid line indicates the cursor 70 after being snapped. The snap function will be described below in further detail.

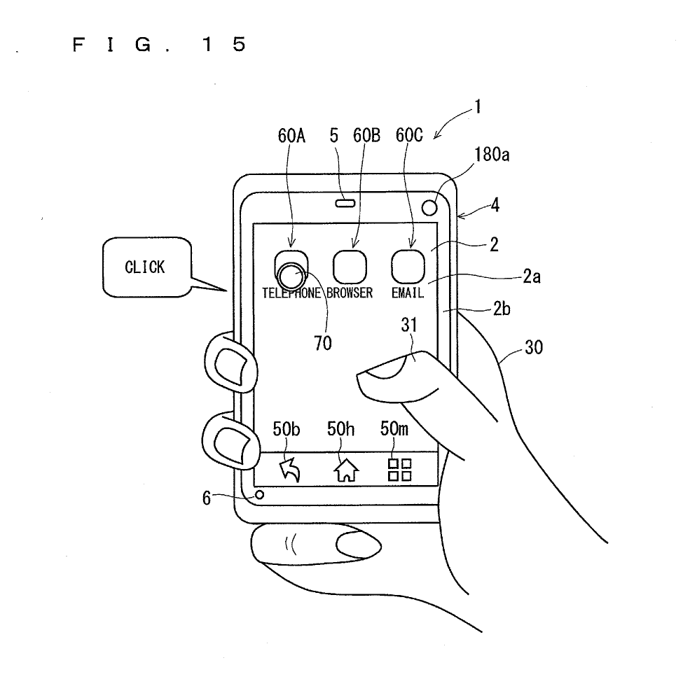

FIG. 14 illustrates a flowchart showing the snap process in the electronic apparatus 1. In one embodiment, the controller 100 controls the display panel 120 to update a display of the display area 2a for every predetermined period of time. When the display of the display area 2a is updated, as illustrated in FIG. 14, in step s1, the controller 100 determines the distance between the cursor 70 currently displayed and each display object currently displayed.

In step s2, next, the controller 100 determines whether a display object located within the second predetermined distance from the cursor 70 (hereinbelow referred to as a “display object in proximity to the cursor”) is present. If the controller 100 determines in step s2 that a display object in proximity to the cursor is not present, the snap process ends. If determining in step s2 that a display object in proximity to the cursor is present, in step s3, the controller 100 identifies a display object in proximity to the cursor with the smallest distance from the cursor 70. In step s4, then, the controller 100 controls the display panel 120 to snap the cursor 70 to the display object in proximity to the cursor identified in step s3 for a predetermined period of time. The controller 100 displays the cursor 70 in the display panel 120 for a predetermined period of time in such a manner that the center of the cursor 70 coincides with the center of the display object in proximity to the cursor, which is closest to the cursor 70, irrespective of the position of the operator 80 detected by the touch panel 130. In one embodiment, in the presence of a plurality of display objects in proximity to the cursor, the cursor 70 is snapped to a display object closest to the cursor 70 among these display objects.

After step s4, step s1 is performed upon update of a display of the display area 2a, and then, the electronic apparatus 1 operates similarly.

As described above, when the cursor 70 approaches a display object, the cursor 70 is snapped to the display object in such a manner that the display object is selected by the operator 70, thus enabling the user to easily select a display object with the cursor 70.

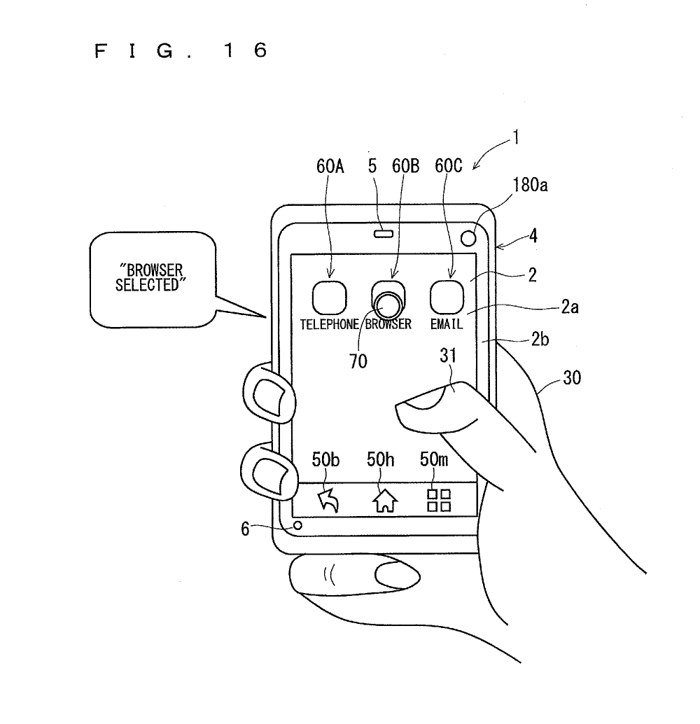

When the cursor 70 is snapped to the display object, as illustrated in FIG. 15, a sound effect (hereinbelow referred to as a “snap sound effect”) for notifying the user that the cursor 70 has been snapped to the display object may be output from the external speaker 170. FIG. 15 illustrates how the external speaker 170 outputs, for example, a sound “click” as a snap sound effect. The snap sound effect may be any other sound effect.

Talkback Function

In the normal mode, the operator 80 serves as a unit for selecting a display object, thus enabling the user to select a display object by directly moving the unit. In the normal mode, thus, the user can select a desired display object relatively easily.

In the cursor-used mode, the cursor 70 that moves in accordance with the movement of the operator 80 serves as a unit for selecting a display object, and accordingly, the user cannot directly move the unit. In the cursor-used mode, thus, the user may have difficulty in selecting a desired display object. In particular, a user, who is an elderly person, has difficulty in selecting a desired display object in many cases. Also, a user, who is a visually impaired person, has difficulty in selecting a desired display object in many cases.

In the cursor-used mode, when a display object is selected by the operator 70, the electronic apparatus 1 outputs a voice of explanation for explaining the selected display object. Specifically, the external speaker 170 outputs the voice of explanation. This enables the user to easily recognize a currently selected display object by listening to the voice of explanation from the electronic apparatus 1. The user can accordingly select a desired display object more easily.

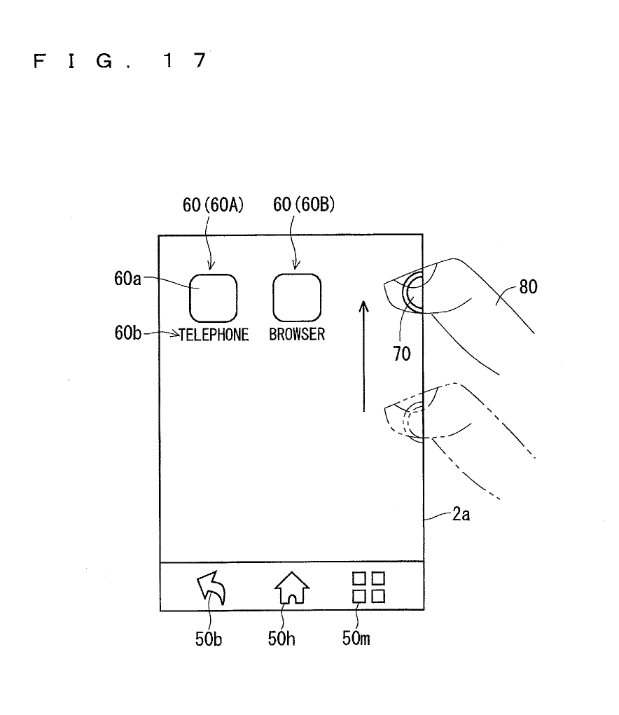

FIG. 16 illustrates an example of the voice of explanation. In the example of FIG. 16, the app icon 60B corresponding to the browser is selected by the operator 70. In the example of FIG. 16, a voice “browser selected” is output as the voice of explanation for explaining the app icon 60B corresponding to the browser.

When the back key 50b is selected by the operator 70, the electronic apparatus 1 outputs, for example, a voice of explanation “back key selected”.

In one embodiment, when an app icon 60 is selected by the operator 70, the controller 100 extracts a text 60b included in the selected app icon 60. The controller 100 then controls the external speaker 170, thus causing the external speaker 170 to output a voice in such a manner that a predetermined text including the extracted text 60b is read. In the example of FIG. 16, the app icon 60B includes the text 60b indicating “browser”, and thus, the external speaker 170 outputs a voice in such a manner that the text “browser selected” including “browser” is read.

The voice of explanation when the app icon 60B corresponding to the browser or the back key 50b has been selected is not limited to the example above.

As described above, when a display object is selected by the operator 70, the electronic apparatus 1 outputs the voice of explanation for explaining the selected display object, thus enabling the user to easily select a desired display object. In particular, the talkback function is very convenient for an elderly person or a visually impaired person. The elderly person or the visually impaired person who uses the electronic apparatus listens to the voice of explanation output from the electronic apparatus 1 to easily recognize a display object currently selected, thus selecting a desired display object more easily.

Initial Position Change Mode

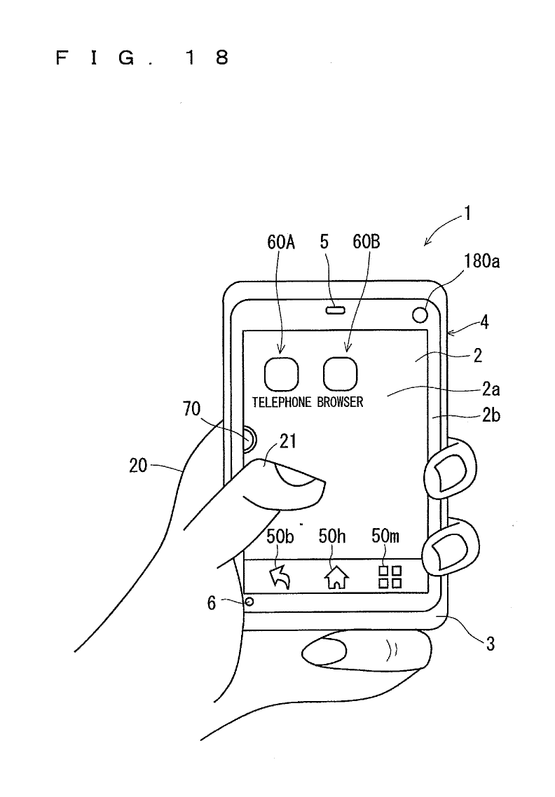

As described above, when the operator 80 has been in contact with or in proximity to the cursor 70 at the initial position for a predetermined period of time or more, the operation mode of the electronic apparatus 1 shifts to the initial position change mode. In the initial position change mode, the initial position of the cursor 70 is changeable. Specifically, when the operator 80 has been in contact with or in proximity to the cursor 70 at the initial position and then the operator 80 moves vertically while being in contact with or in proximity to the display area 2a and stops, the initial position of the cursor 70 moves to the position of the operator 80 in the display area 2a. FIG. 17 illustrates how the initial position of the cursor 70 is changed from the center to the upper end portion of the display area 2a in the longitudinal direction at the right edge of the display area 2a.

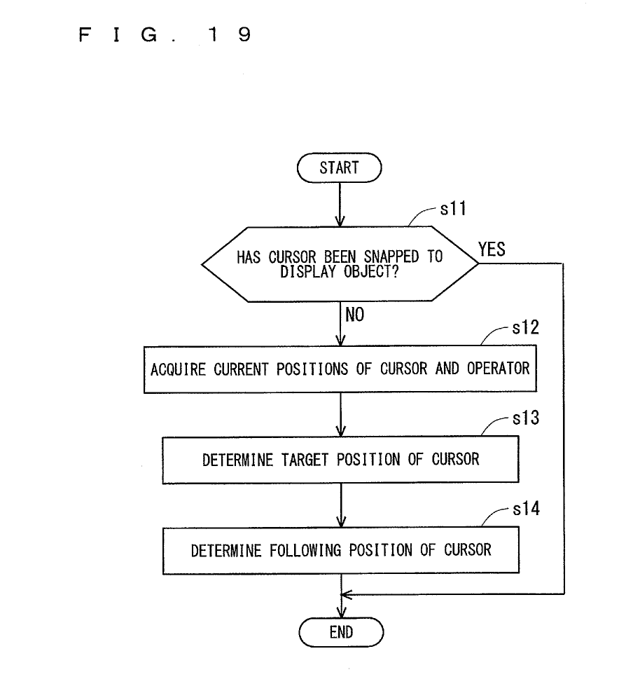

In the initial position change mode, the operator 80 has been in contact with or in proximity to the cursor 70 at the initial position for a predetermined period of time or more, and then, when the operator 80 then moves to the left edge of the display area 2a while being in contact with or in proximity to the display area 2a and stops, the initial position of the cursor 70 is moved to the position of the operator 80 in the display area 2a. Consequently, as illustrated in FIG. 18, the initial position of the cursor 70 is set at the left edge of the display area 2a. The user can accordingly operate the electronic apparatus 1 with a left hand more easily. The initial position of the cursor 70 is moveable vertically also at the left edge of the display area 2a.

The initial position of the cursor 70 is changeable as described above, and accordingly, the user can set the position, at which the user can easily operate the electronic apparatus 1, as the initial position of the cursor 70. The operability of the electronic apparatus 1 is thus improved.

If the initial position of the cursor 70 is set at the left edge of the display area 2a, the rightward direction from the initial position of the cursor 70 is a +X direction in the XY orthogonal coordinate system.

Variations

Variations of the electronic apparatus 1 according to one embodiment will be described below.

First Variation

In the cursor-used mode, just a slight movement of the operator 80 moves the cursor 70 greatly, and accordingly, the cursor 70 may not move smoothly. Besides, the position of the cursor 70 may vibrate. The user thus may have difficulty in selecting a display object with the cursor 70.

Here, the display panel 120 is controlled by the controller 100 to move the cursor 70 toward the target position in such a manner that a speed of movement of the cursor 70 gradually decreases in the display area 2a. The display panel 120 gradually brings the cursor 70 closer to a target position in the display area 2a. This enables the cursor 70 to move smoothly and also restricts the cursor 70 from vibrating. The user can accordingly select a display object with the cursor 70 more easily. This point will be described below in detail.

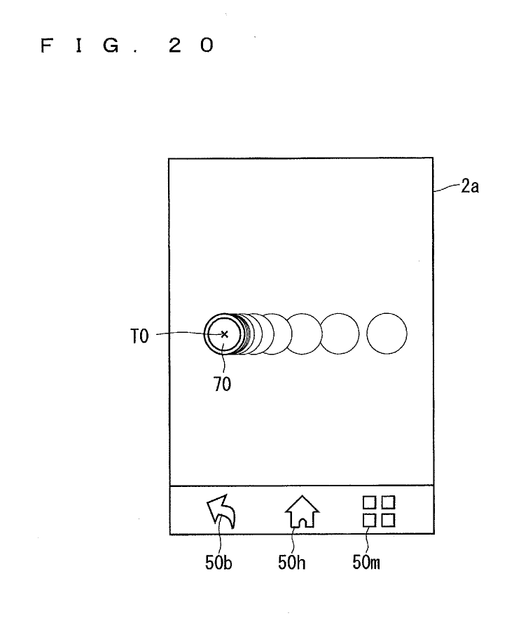

FIG. 19 illustrates a flowchart showing a process of updating a cursor position in the electronic apparatus 1 according to one variation. The process of updating a cursor position illustrated in FIG. 19 is performed at a timing at which a display of the display area 2a is updated.

At a timing at which a display of the display area 2a is updated, as illustrated in FIG. 19, in step s11, the controller 100 determines whether the cursor 70 has been snapped to a display object. If the controller 100 determines in step s11 that the cursor 70 has been snapped to the display object, the process of updating a cursor position ends. If the controller 100 determines in step s11 that the cursor 70 has not been snapped to the display object, in step s12, the controller 100 acquires the current positions of the cursor 70 and the operator 80.

In step s13, then, the controller 100 uses the current position of the operator 80 to determine a target position of the cursor 70. Letting the X coordinate and the Y coordinate of the target position of the cursor 70 be Sxt and Syt, respectively, and the X coordinate and the Y coordinate of the current position of the operator 80 be Ux0 and Uy0, respectively, Sxt and Syt are respectively expressed by Expressions (3) and (4) below.

Sxt=Dx×Ux0 (3)

Syt=Dy×Uy0 (4)

From Expression (3), the X coordinate Sxt of the target position of the cursor 70 is Dx-times the X coordinate Ux0 of the current position of the operator 80. From Expression (4), the Y coordinate Syt of the target position of the cursor 70 is Dy-times the Y coordinate Uy0 of the current position of the operator 80. In step s13, the controller 100 determines the X coordinate and the Y coordinate of the current position of the cursor 70 using Expressions (3) and (4).

In step s14, next, the controller 100 uses the target position of the cursor 70 and the current position of the cursor 70 to determine the following position of the cursor 70. Letting the X coordinate and the Y coordinate of the following position of the cursor 70 be Sx1 and Sy1, respectively, and the X coordinate and the Y coordinate of the current position of the cursor 70 be Sx0 and Sy0, respectively, Sx1 and Sy1 are expressed by Expression (5) below.

$$[ \begin{matrix}Sx 1 \\ Sy 1\end{matrix} ] = ( [ \begin{matrix}Sxt \\ Syt\end{matrix} ] - [ \begin{matrix}Sx 0 \\ Sy 0\end{matrix} ] ) K + [ \begin{matrix}Sx 0 \\ Sy 0\end{matrix} ] \qquad ( 5 )$$

In Expression (5), K is a coefficient, where 0<K<1. For example, K is set to 0.25. Letting the position vector indicating the current position of the cursor 70 be P0=(Sx0, Sy0), the position vector indicating the following position of the cursor 70 be P1=(Sx1, Sy1), and the position vector indicating the target position of the cursor 70 be T=(Sxt, Syt), Expression (5) is expressed by Expression (6).

P1=(T−P0)×K+P0 (6)

From Expressions (5) and (6), the position (X coordinate and Y coordinate) obtained by adding a value, which is obtained by multiplying a distance between the current position and the target position of the cursor 70 by K (0<K<1), to each of the X coordinate and the Y coordinate of the current position of the cursor 70 is the following position (X coordinate and Y coordinate) of the cursor 70. In step s14, the controller 100 obtains the X coordinate and the Y coordinate of the following position of the cursor 70 using Expression (5). After the execution of step s14, the process of updating a cursor position ends.

In updating a display of the display area 2a, the display panel 120 displays the cursor 70 at the following position of the cursor 70 that has been obtained by the controller 100.

The process from steps s11 to s14 is performed every time a display of the display area 2a is updated, whereby the cursor 70 moves toward the target position in such a manner that a speed of movement of the cursor 70 gradually decreases in the display area 2a, as long as the target position of the cursor 70 is constant, or, the position of the operator 80 remains unchanged. As illustrated in FIG. 20, the cursor 70 gradually approaches a target position TO. This allows the cursor 70 to move smoothly and also restricts the cursor 70 from vibrating. The user can thus select a display object with the cursor 70 more easily. The circles made in thin lines illustrated in FIG. 20 each indicate the position of the cursor 70 at an update of a display of the display area 2a. The circles indicate the path of the cursor 70.

Second Variation

In the cursor-used mode, the user indirectly operates the cursor 70, and accordingly, the user may move the operator 80 away from the display area 2a with a display object selected by the operator 70, though the user attempts to cause the electronic apparatus 1 to end the cursor-used mode. In particular, if many display objects are displayed in the display area 2a, the user is highly likely to move the operator 80 away from the display area 2a with a display object selected by the operator 70, though the user attempts to cause the electronic apparatus 1 to end the cursor-used mode. Consequently, the user may inadvertently cause the electronic apparatus 1 to perform the process associated with the display object.

Here, a predetermined display object displayed in the display area 2a functions as a display object for ending a cursor display mode (hereinbelow referred to as a “display object for end instruction”). In the cursor-used mode, the user can directly operate only the display object for end instruction with the operator 80 among the display objects displayed in the display area 2a.

In one variation, for example, the back key 50b is used as a display object for end instruction. The back key 50b in the cursor-used mode does not function as an operation key for returning a display of the display area 2a to the last display but functions as an operation key for ending the cursor display mode. In the cursor-used mode, when the user moves the operator 80 to be located on the back key 50b while bringing the operator 80 into contact with or in proximity to the display area 2a and then moves the operator 80 away from the display area 2a, the controller 100 shifts the cursor-used mode to the normal mode.

Also in such a case, when the operator 80 moves away from the display area 2a with the display object not selected by the operator 70, the operation mode of the electronic apparatus 1 changes from the cursor-used mode to the normal mode. When the operator 80 moves away from the display area 2a with the display object for end instruction selected by the operator 70, the operation mode of the electronic apparatus 1 changes from the cursor-used mode to the normal mode.

The display object for end instruction directly operable with the operator 80 is displayed in the display area 2a as described above, so that the user can cause the electronic apparatus 1 to end the cursor-used mode more reliably.

Third Variation

Although the snap function is always executed in the cursor-used mode in the examples above, the user may operate the display area 2a with the operator 80 in the normal mode to set whether to execute the snap function in the cursor-used mode.

Although the talkback function is always executed in the cursor-used mode in the examples above, the user may operate the display area 2a with the operator 80 in the normal mode to set whether to execute the talkback function in the cursor-used mode.

The execution of the snap function may also be set automatically when the user sets the execution of the talkback function in the cursor-used mode. Alternatively, the execution of the talkback function may be set automatically when the user sets the execution of the snap function in the cursor-used mode.

In the case where the execution of the talkback function in the cursor-used mode is set assuming the use of the electronic apparatus 1 by a visually impaired person, the cursor 70 may not be displayed. In this case, the electronic apparatus 1 creates a virtual cursor, which moves in response to the movement of the operator 80 similarly to the cursor 70 and is not displayed in the display area 2a, and uses the virtual cursor to select a display object or perform the process associated with the display object.

Other Variations

Although the electronic apparatus 1 has both the snap function and the talkback function in the examples above, it may have only one of these functions.

Also in the normal mode, when a display object is selected by the operator 80, the external speaker 170 may output a voice of explanation for explaining the display object.

Although the cursor 70 is always displayed at the initial position in the normal mode in the examples above, the user may operate the display area 2a to set a display or no display of the cursor 70 in the normal mode.

Although the examples above have described, as an example, the case where one embodiment of the present disclosure is applied to a mobile phone, one embodiment of the present disclosure is also applicable to mobile electronic apparatuses other than mobile phones such as smartphones, for example, tablet terminals.

While the communication system 1 has been shown and described in detail, the foregoing description is in all aspects illustrative and not restrictive. Also, the variations above are applicable in combination as long as they are consistent with each other. It is therefore understood that numerous modifications and variations can be devised without departing from the scope of the disclosure.

1. An electronic apparatus comprising:
a display configured to perform a display in a display area; and
a detector configured to detect an operation performed on the display area by an operator,
wherein the display is configured to
display, in the display area, a cursor for selecting a display object to be displayed in the display area,
move the cursor in the display area in accordance with a movement of the operator in the display area detected by the detector and move the cursor by an amount of movement greater than an amount of movement of the operator, and
when the cursor approaches within a predetermined distance of a display object in the display area, snap the cursor to the display object in such a manner that the display object is selected by the operator.

2. The electronic apparatus according to claim 1, further comprising
a sound output unit configured to output, when a display object to be displayed in the display area is selected by the operator, a voice of explanation for explaining the display object.

3. The electronic apparatus according to claim 1, further comprising
a sound output unit configured to output a sound when the cursor is snapped to the display object in the display area.

4. An electronic apparatus comprising:
a display configured to perform a display in a display area;
a detector configured to detect an operation performed on the display area by an operator; and
a sound output unit configured to output a sound,
wherein
the display is configured to
display, in the display, a cursor for selecting a display object to be displayed in the display, and
move the cursor in the display area in accordance with a movement of the operator in the display area detected by the detector and move the cursor by an amount of movement greater than an amount of movement of the operator, and
the sound output unit outputs, when a display object to be displayed in the display area is selected by the operator, a voice of explanation for explaining the display object.

5. The electronic apparatus according to claim 1, wherein the display moves the cursor toward a target position in such a manner that a speed of movement of the cursor gradually decreases in the display area.

6. The electronic apparatus according to claim 4, wherein the display moves the cursor toward a target position in such a manner that a speed of movement of the cursor gradually decreases in the display area.

7. A non-transitory computer-readable recording medium configured to store a control program that controls an electronic apparatus including a display area, the recording medium storing the control program configured to cause the electronic apparatus to execute the steps of:
(a) detecting an operation performed on the display area by an operator; and
(b) displaying, in the display area, a cursor for selecting a display object to be displayed in the display area,
wherein in the step (b),
the cursor is moved in the display area in accordance with a movement of the operator in the display area detected in the step (a), and the cursor is moved by an amount of movement greater than an amount of movement of the operator, and
when the cursor approaches within a predetermined distance of the display object in the display area, the cursor is snapped to the display object in such a manner that the display object is selected by the operator.

8. A non-transitory computer-readable recording medium configured to store a control program that controls an electronic apparatus including a display area, the recording medium storing the control program configured to cause the electronic apparatus to execute the steps of:
(a) detecting an operation performed on the display area by an operator;
(b) displaying, in the display area, a cursor for selecting a display object to be displayed in the display area; and
(c) outputting a sound,
wherein
in the step (b), the cursor is moved in the display area in accordance with a movement of the operator in the display area detected in the step (a), and the cursor is moved by an amount of movement greater than an amount of movement of the operator, and
in the step (c), when a display object to be displayed in the display area is selected by the operator, a voice of explanation for explaining the display object is output.

9. An operation method of an electronic apparatus including a display area, the method comprising:
(a) detecting an operation performed on the display area by an operator; and
(b) displaying, in the display area, a cursor for selecting a display object to be displayed in the display area,
wherein in the step (b),
the cursor is moved in the display area in accordance with a movement of the operator in the display area detected in the step (a), and the cursor is moved by an amount of movement greater than an amount of movement of the operator, and
when the cursor approaches within a predetermined distance of the display object in the display area, the cursor is snapped to the display object in such a manner that the display object is selected by the operator.

10. An operation method of an electronic apparatus including a display area, the method comprising:
(a) detecting an operation performed on the display area by an operator;
(b) displaying, in the display area, a cursor for selecting a display object to be displayed in the display area; and
(c) outputting a sound,
wherein
in the step (b), the cursor is moved in the display area in accordance with a movement of the operator in the display area detected in the step (a), and the cursor is moved by an amount of movement greater than an amount of movement of the operator, and
in the step (c), when a display object to be displayed in the display area is selected by the operator, a voice of explanation for explaining the display object is output.
